(19) United States
(12) Patent Application Publication
(10) Pub. No.: US 2007/0007701 A1
(43) Pub. Date: Jan. 11, 2007

(54) Shock absorber, particularly for commercial vehicles or the like

(76) Inventors: Pasquale Lorusso, Alamura (IT); Giuseppe Lorusso, Altamura (IT)

Correspondence Address: YOUNG & THOMPSON, 745 SOUTH 23RD STREET, 2ND FLOOR, ARLINGTON, VA, 22202, US

(21) Appl. No.: 10/556,035

(22) PCT Filed: Feb. 13, 2004
(86) PCT No.: PCT/IT04/00058

§ 371 Date: Jul. 11, 2006

(30) Foreign Application Priority Data
May 9, 2003 (IT) RM2003U000083

(51) Int. Cl. F16M 1/00

(52) U.S. Cl. 267/139

(57) ABSTRACT

A shock absorber to absorb the shocks caused when a transport motor vehicle, a truck or the like approaches the vertical wall of a loading platform or to absorb changes of distance between the vehicle and the wall of the loading platform upon loading/unloading, including at least one support or contact member (1) which is connected to a fixed member (6) by mechanical connecting means (10) of dampening material which allows said support member to shift axially by changing its distance with respect to said fixed (6) member of the shock absorber.

The present finding relates to an improved shock absorber to be used in particular in the bodies of trucks and/or transport motor vehicles, i.e. a device which absorbs the shocks as a truck or the like approaches a loading platform and is able to overcome all of the problems caused by the height difference between the vehicle and the loading platform upon loading/unloading.

As an alternative to the fixed rubber bumper installed to the horizontal rear body and/or to the end of chassis, trucks of the state of art are provided with shock absorbers consisting of cylinders rotating about a horizontal axis, as disclosed in Patent EP 0 648 644, or cylinder with a vertical, axis, or rubber ball bodies housed in suitable recesses arranged in the bumper or the shock absorber of the vehicle in which such ball bodies are able to rotate.

However, all of the above-mentioned solutions do not fully satisfy the requirements of users as they are not able to absorb any unevenness of the contact surface. In known devices, if the wall against which the rear portion of the truck body rests is shifted upwards or downwards because of a load change, the distance between the resting wall and the truck could be reduced, thus providing axial stresses that could possibly damage the shock absorber.

Moreover, the functionality of such shock absorbers provided with rotating members is strictly bound to the necessity that such rotating members keep the capability of a free rotation in time, however such rotation is often hampered by the undesired accumulation of debris and/or dirt caused both by the loading/unloading and the road circulation (mud, dust, etc.).

The main object of the finding is then to overcome such problems by providing a shock absorber provided with protected dampening means which is able to fully absorb or at least to limit the harmful effects of shocks in the axial direction, such as for example those that might occur as the truck approaches a loading platform.

This has been accomplished according to the present finding by providing a shock absorber or buffer for truck, characterized in that there is provided at least one support or contact member which is connected to a fixed member by mechanical connecting means of dampening material which allows such support member to shift axially by changing its distance with respect to such fixed member.

According to the disclosed finding, such support member acts as a “sliding shoe” for side shifts between the shock absorber and the contact surface to which the former rests or is pressed, as well as for axial shifts to absorb changes of distance between the vehicle and the wall of the loading platform.

An embodiment of the finding is shown only by way of a not limiting example in the accompanying drawings in which:

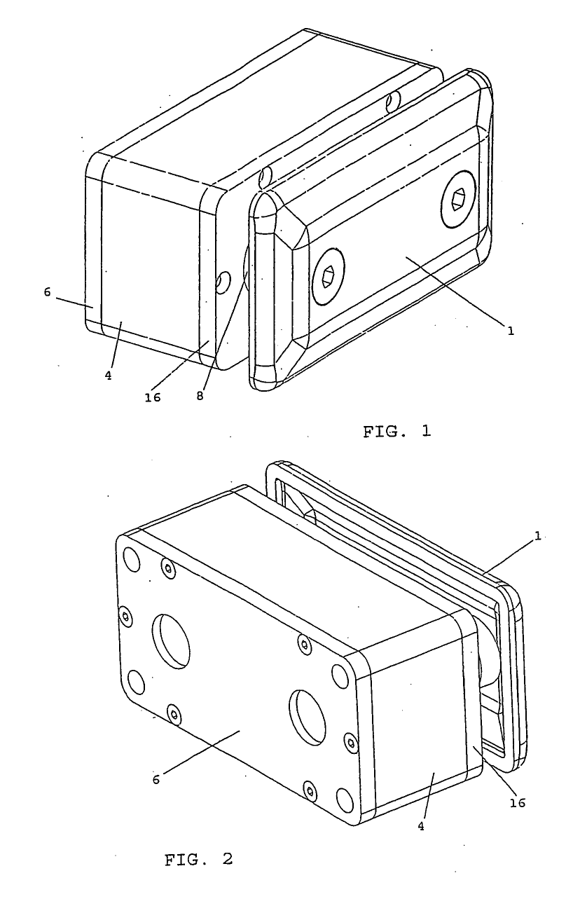

FIGS. 1 and 2 are perspective front and rear views of the finding, respectively; and

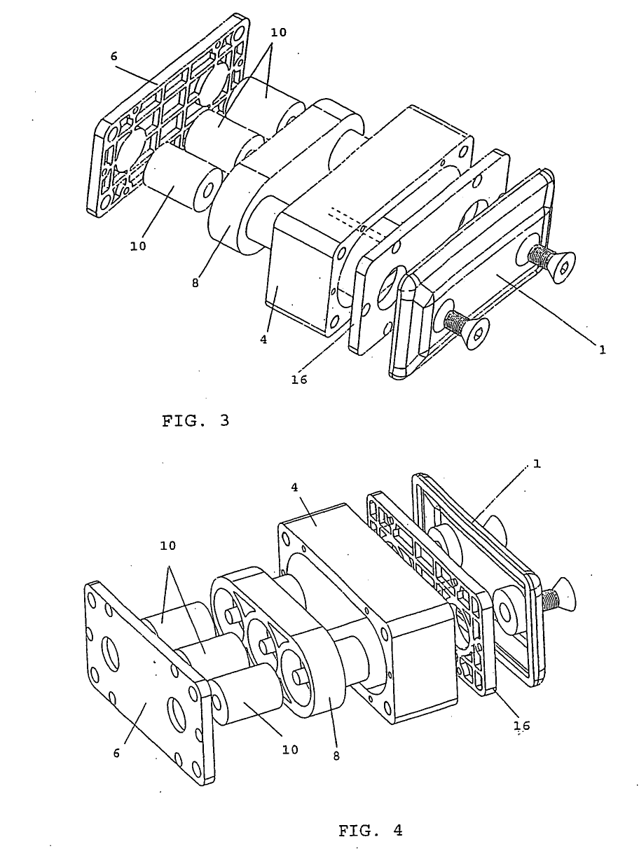

FIGS. 3 and 4 are exploded, front and rear views of the finding, respectively.

Referring particularly to the above Figures, the disclosed shock absorber includes, in combination, a preferably box-like fixed member 4 with an essentially parallelepiped shape provided with a front cover 16 and a rear base 6 as well as with one or more dampening members 10 which are, kept in their positions by a suitable spacer 8 that is free of moving to a direction perpendicular to the rear base 6 and the box-like fixed member 4, the support member or front shoe 1 made preferably of an antifriction material or other materialable to slide on the surfaces on which it rests being rigidly connected to such spacer 8.

According to the finding, such contact shoe 1 is able to shift perpendicular to its contact surface and to absorb resiliently any shock as the vehicle approaches the wall of the loading platform, as well as the little distance changes that can occur upon loading/unloading if the wall of the loading platform is not perfectly even and/or parallel to the loading body of the vehicle.

Moreover, the shoe has bevelled, rounded, corners to ensure the greatest ease of sliding on the wall of the loading platform in case side shifts of the shoe occur upon loading/unloading.

At last, it should be appreciated that the shock absorber disclosed can be installed preferably at the rear end of the loading body of a vehicle, however, it can also be installed with the same effectiveness of operation and without any modification to the wall of the loading platform which the vehicles have to approach. Of course, in the latter case, the height at which the shock absorber is secured depends on the model of vehicle which will approach.

According to a peculiar characteristics of the finding, the dampening means consists of preferably tubular cylinders 10 of elastic material which are capable of being deformed, by reducing their height by the compression exerted by shoe 1 connected thereto.

In the embodiment shown, shoe 1 is secured to the dampening means by a spacer 8. In other words, shoe 1 is firmly secured to one end of each elastic member 10, and the latter is connected with its opposite end to the fixed base 6 of the shock absorber. Thus, the elastic action of each dampening member 10 is performed by a temporary relative shift of shoe 1 that approaches the fixed base 6 and then leaves it up to the rest position.

It should be noted that, in order to guide shoe 1 inside the box-like body of the shock absorber, spacer 8 has an outer cylindrically shaped body matching the inner cylindrical shape of the box-like fixed body 4 so that the side shifts are limited.

The present invention has been described and illustrated according to a preferred embodiment thereof, however, it should be understood that anyone skilled in the art can make technically, functionally equivalent modifications and/or replacements without departing from the scope of the present industrial invention.

1-10. (canceled)

11. A shock absorber apt to absorb the shocks caused when a transport motor vehicle, a truck or the like approaches the vertical wall of a loading platform or apt to absorb changes of distance between the vehicle and the wall of the loading platform upon loading/unloading, provided with at least one support or contact member (1) which is connected to a fixed member (6) by mechanical connecting means (10) of dampening material which allows said support member to shift perpendicularly with respect to said fixed member (6) of the shock absorber by changing its distance with respect to the fixed member (6) itself, characterized in that it includes, in combination, a box-like member (4) with an essentially parallelepiped shape provided with a front cover (16) and a rear base (6) as well as with one or more dampening members (10) which are kept in their positions by a suitable spacer (8) that is free of moving to a direction perpendicular to the rear base (6) and the box-like fixed member (4), support member or front shoe (1) made of an antifriction material or other material able to slide on the surfaces on which it rests being rigidly connected to said spacer (8).

12. The shock absorber according to claim 11, characterized in that said support member (1) acts as a “sliding shoe” for side shifts between the shock absorber and the contact surface to which the former rests or is pressed, as well as for axial shifts to absorb changes of distance between the vehicle and the wall of the loading platform.

13. The shock absorber according to the claim 11, characterized in that said contact shoe (1) is able to shift perpendicular to its contact surface, in both vertical and horizontal directions, and to absorb resiliently any shock as the vehicle approaches the wall of the loading platform, as well as the little distance changes that can occur upon loading/unloading when the wall of the loading platform is not perfectly even and/or parallel to the loading body of the vehicle.

14. The shock absorber according to claim 11, characterized in that said support member or shoe (1) has bevelled, rounded corners, thereby obtaining to ensure the greatest ease of sliding on the wall of the loading platform in case side shifts of the shoe occur upon loading/unloading.

15. The shock absorber according to claim 11, characterized in that said dampening means consists of tubular cylinders (10) of elastic material which are capable of being deformed by reducing their height by the compression exerted by shoe (1) connected thereto which moves with respect to the fixed member (6).

16. The shock absorber according to claim 11, characterized in that the support member or shoe (1) is firmly secured to one end of each said dampening member (10), and the latter is connected with its opposite end to the fixed base (6) of the shock absorber.

17. The shock absorber according to claim 11, characterized in that, in order to guide shoe (1) inside the box-like body (4) of the shock absorber, spacer (8) has an outer cylindrically shaped body matching the inner cylindrical shape of the box-like fixed body (4) so that the side shifts of shoe (1) are limited.

18. A vehicle with a loading body and a shock absorber according to claim 11, characterized in that said shock absorber is installed at the rear end of the loading body.

19. A loading bay or platform and a shock absorber according to claim 11, characterized in that said shock absorber is installed to the wall of the loading platform which the loading bodies of the vehicles have to approach, the height at which the shock absorber is applied depending in this case on the model of vehicle which will approach.

20. The shock absorber according to claim 13, characterized in that, in order to guide shoe (1) inside the box-like body (4) of the shock absorber, spacer (8) has an outer cylindrically shaped body matching the inner cylindrical shape of the box-like fixed body (4) so that the side shifts of shoe (1) are limited.
